(19) United States
(12) Patent Application Publication
(10) Pub. No.: US 2021/0198811 A1
(43) Pub. Date: Jul. 1, 2021

(54) Multi-Component Fibre and Production Method

(71) Applicants: Universität Paderborn, Paderborn (DE); Rheinisch-Westfälische Technische Hochschule (RWTH) Aachen, Aachen (DE)

(72) Inventors: Wolfgang Bremser, Paderborn (DE); Oliver Ingolf Strube, Paderborn (DE); David Wedegärtner, Paderborn (DE); Thomas Gerhard Gries, Aachen (DE); Davide Pico, Aachen (DE); Alexander Lüking, Aachen (DE); Robert Brüll, Aachen (DE)

(21) Appl. No.: 16/755,722

(22) PCT Filed: Oct. 12, 2018
(86) PCT No.: PCT/EP2018/077885

§ 371 Date: Apr. 13, 2020

(30) Foreign Application Priority Data
Oct. 13, 2017 (DE) 10 2017 123 922.7

(51) Int. Cl. D01D 5/38; D01F 8/18; D01D 11/06; C03C 25/285; C03C 3/091; C03C 13/00; C08J 5/24

(52) U.S. Cl. CPC D01D 5/38; D01F 8/18; D01D 11/06; C03C 25/285; C03B 37/02; C03C 13/00; C08J 5/24; D10B 2101/06; C03C 3/091

(57) ABSTRACT

The invention relates to a method for producing a multicomponent fiber, wherein the fiber is formed from a plurality of filaments, where the filaments each have a core and a thermoplastic sheath, and where the sheath is generated during the production of the filaments by in situ polymerization of monomers or oligomers of the thermoplastic on the surface of the core, and also to multicomponent fibers produced accordingly and to organosheets produced therefrom.

The invention pertains to the field of fiber composite plastics and more particularly of consolidated, thermoplastic, semifinished, continuous fiber reinforced products.

A fiber composite plastic (FCP) is a fiber reinforced engineering material composed of reinforcing fibers and a plastics matrix. Fiber reinforced components are increasingly being used in automotive and aircraft construction. Thermoplastic fiber composite components with continuous fiber reinforcement are generally produced on the basis of what are called organosheets. “Organosheet” is a customary term for consolidated, thermoplastic, semifinished, continuous fiber reinforced products. In these organosheets, the fibers are surrounded by a matrix of thermoplastic. The continuous fibers in this case may be present, for example, as a textile structure in the form, for example, of a unidirectional layer or a woven, laid or braided fabric. “Continuous fiber reinforced” means that the length of the fibers serving for reinforcement is limited essentially by the size of the components produced or the dimensions of organosheets used, but there is essentially no interruption to a fiber within a component or organosheet. The production of a component typically involves the production, in a first operation, of platelike, preconsolidated organosheets, which in a second operation are subjected to forming and in-mold coating to give the ultimate structural component.

Commercial organosheets featuring film impregnation are generally produced by weaving together glass fibers into sheets and layering these sheets stackwise with thermoplastic films produced by film extrusion, in a method known as “film stacking”. Platelike organosheets are generally produced in a continuous operation on what are called double belt presses. In the subsequent step of making up, the semifinished products obtained are cut to size and thereafter consolidated. The consolidation following the fabric-forming and making-up operations is a very largely established operation for production of thermoplastic FCPs. The embedding of the fibers in the organosheet by film stacking methods, however, is highly nonuniform, and not nearly all the filaments are entirely surrounded by plastic. This results in instances of fiber-fiber contact and of air inclusion, and in low fiber volume contents of only 30 to 60 vol %. As a result of the layered structure comprising fibers and thermoplastic films, furthermore, the mechanical load-bearing capacity is well below the theoretical limit. It is necessary, moreover, to apply an expensive size as a binder between fiber and plastic.

Besides this method, there are also organosheets available on the market, based on hybrid yarns and hybrid woven fabrics, that are produced by mixing matrix fibers and reinforcing fibers with one another in a step referred to as commingling. Even this, however, does not result in sufficient comixing of matrix and reinforcing fibers, and the resultant organosheets display nonuniform distribution, some fibers not wetted by matrix, and also low fiber volume contents. Overall, in continuous glass fiber reinforced thermoplastics, the fiber volume contents achievable in the finished product are—at below 60%—low in comparison to the theoretical maximum. Each of these aspects diminishes the mechanical properties of the products, meaning that the potential of the mechanical properties of organosheets is not exhausted in reality. This also leads to inefficient use of the expensive matrix in comparison to the favorably priced glass fibers.

Thermoplastic-sheathed glass fibers are known from other technical fields. For instance, US 2017/0003446 A1 discloses optical glass fibers having a thermoplastic sheath and a diameter of 220-260 m. Sheathed fibers of this kind are generated by pultrusion methods like those discussed, for example, by A. Luisier et al. in Composites: Part A 34, 2003, pages 583-595, by the melting of thermoplastics onto prefabricated glass fibers. The operating speeds of these methods, however, are situated only in the range from several centimeters up to about 1 m/min, and are therefore unusable or unprofitable for the production of continuous threads.

It was therefore the object of the present invention to provide a method for producing thermoplastic, semifinished, continuous fiber reinforced product. A particular object of the invention was to provide a method allowing the production of such semifinished products with an increased fiber volume fraction.

The object is achieved through the features of the independent claims. Advantageous embodiments are specified in the dependent claims.

The method of the invention for producing a multicomponent fiber is distinguished in that the fiber is formed from a plurality of filaments, where the filaments each have a core and a thermoplastic sheath, and where the sheath is generated during the production of the filaments by in situ polymerization of monomers or oligomers of the thermoplastic on the surface of the core.

The present invention provides for the combining of the thermoplastic with the material of the fiber core to take place during the actual production of the filaments, by means of a die drawing method or spinning method, for example. In this case, monomers, dimers, or oligomers are applied and polymerized in situ. Hence the fiber-plastic composite is formed during fiber production itself, and not only through subsequent combination of the two components. As a result it is possible, in the case of glass fiber drawing methods, for example, to coat each individual glass filament with plastic. Through the method, a uniform and complete wetting is achieved during actual production and/or before the winding of the fiber on the reel. The method utilizes the reactive surface of the core material during production of the filaments, and so circumvents the subsequent need to use size. By the application of the monomers it is possible in particular to achieve effective adhesion on thin filaments, thereby allowing a high-throughput industrial production procedure which is sparing with thermoplastic material and is therefore economic.

As a result of the use of a two-component fiber, with a glass core and a thermoplastic sheath, for example, the matrix fraction of the finished product is significantly reduced. It has been possible to realize organosheets having a volume content of glass of more than 75% and more particularly 80%. By virtue of the proposed production, however, organosheets having a fiber volume content of up to the theoretical limit of 91% can be produced. Moreover, the fiber/matrix distribution in an organosheet produced therefrom is uniform. In particular, the production of organosheets having a defined fiber volume content throughout the component is possible. The term “organosheet” refers to thermoplastic, semifinished, continuous fiber reinforced products. The terms are used synonymously hereinafter.

Furthermore, a variety of operating steps in the fabrication process can be omitted, because the plastic is introduced at the glass fiber production stage itself. For instance, methods for producing organosheets and/or components based thereon can be reduced by a number of steps—to exclude, for example, the double belt pressing or the film stacking. The achievable savings in materials, time, and energy also make it possible to score a distinct improvement in the environmental balance of lightweight construction applications. Advantageously, in terms of materials technology, the mechanical properties can also be improved—for example, the elasticity modulus or the strength—based on equal component volumes.

The production can be transposed to different kinds of thermoplastics and fibers, and a defined combination of materials can be selected according to the desired application. The multicomponent fiber is preferably a two-component fiber, more particularly a thermoplastic-glass fiber. The application of the plastic by in situ polymerization can be integrated into customary production operations of organic or inorganic fibers producible by melt spinning or by die drawing methods, an example being the glass fiber drawing method. In fiber embodiments, the core of the filaments is formed of glass, basalt, ceramic, metal, or plastic, preferably of glass. The method may in particular be a method for producing a two-component glass/thermoplastic fiber, in which case the glass core of the filaments is produced by glass fiber drawing methods and the sheath is generated during the drawing operation by in situ polymerization of monomers or oligomers of the thermoplastic on the surface of the filament cores.

In embodiments, the filament cores are produced by die drawing methods or spinning methods. The in situ polymerization of the thermoplastic on the surface of the filament cores directly in the spinning operation allows for industrial drawing speeds in the production of the multicomponent or two-component fibers. Hence the drawing speed may preferably be at least 1000 m/min. Drawing operations for producing sheathed continuous glass fibers can be carried out on customary glass fiber spinning lines at a speed in the range from ≥30 m/min to ≤4000 m/min. This constitutes a great advantage over known methods—slow and therefore not very industrially profitable—for generating sheathed fibers. Thin continuous fibers in particular can be profitably produced on the industrial scale by this means.

A key feature of the production method of the invention is that it is not the ready-polymerized thermoplastic polymer that is applied, but rather its monomers or oligomers. Polymerization from the monomers and/or oligomers hence takes place only on the fiber. The term “oligomer” refers to a molecule composed of several units of a defined number of monomers. An oligomer may have two, three, four, or more units, and may for example be a dimer or trimer. Preference is given to applying monomers and/or dimers of a thermoplastic. Depending on the polymer, the same or different monomers or oligomers are applied for polymerization into homopolymers or copolymers.

Suitable thermoplastic polymers are those customary polymers which can be used for producing organosheets, such as polypropylene, polystyrenes, polyacrylates, polyvinylpolypyrrolidone, polyamide, or copolymers thereof. Polyacrylates in particular are preferred. Preferred monomers are selected from hydroxyethyl acrylate, ethyl acrylate, tert-butyl acrylate, hydroxyethyl methacrylate, methyl methacrylate, methacrylic acid, butyl acrylate, isooctyl acrylate, styrene, N-vinylpyrrolidone, cyclohexyl acrylate, and mixtures thereof. The precursor composition containing monomers or oligomers may further comprise a mixture of different monomers—for example, a mixture of hydroxyethyl acrylate and tert-butyl acrylate. The composition of the thermoplastic can also be modified by addition of additives, examples being polymer particles. This allows the properties of the two-component fiber to be adjusted to specific applications. Moreover, the composition may comprise triethanolamine or other additives which catalyze the polymerization. There may also be additives included, furthermore, which modify mechanical, optical, or other properties of the polymer matrix. The mixture of the monomers, oligomers, and—optionally—initiators and additives is also termed the precursor.

The application of a monomer and/or oligomer composition in liquid form has advantages over application of polymer in powder form, in particular, in the context of application to thin filaments. Firstly, then, the precursor mixture adheres well to the filaments. Furthermore, this mixture can be applied efficiently and without large excess of material, by virtue of the liquid composition. This permits economic production. Moreover, excess precursor composition can be captured and used again. The monomers, dimers, or oligomers, or composition comprising them, can be applied uncomplicatedly by spray or roll application.

The in situ polymerization on the fiber is initiated by an introduction of energy, more particularly by radiation, preferably by ultraviolet (UV) radiation. The in situ polymerization is, in particular, a radical polymerization. For this purpose the precursor composition may comprise customary photoinitiators or UV initiators, or thermal initiators, the type thereof being dependent on the energy introduction and monomer system used. In the case of the radically initiated polymerization of acrylates, methacrylates, styrene, and other vinyl-containing compounds, and also copolymers thereof, good results have been achieved, for example, with the photoinitiator Irgacure® 651 (2,2-dimethoxy-1,2-diphenylethan-1-one).

The fraction of initiator here, more particularly of photoinitiator, may be in the range from ≥1 mass % to ≤5 mass %, preferably in the range from ≥4 mass % to ≤5 mass %, based on 100 total mass % of monomer and the photoinitiator. It has been determined that the fraction of plastic on the glass fibers was lower when using 5 mass % of initiator. By this means it is possible to attain a higher fraction of glass core in a semifinished product.

Further proposed is an apparatus for producing a multicomponent fiber, where the apparatus comprises at least the following components:
a plurality of dies for forming the cores of a plurality of filaments,
at least one applicator for applying monomers or oligomers of a thermoplastic to the cores of the filaments,
at least one source of energy or radiation for in situ polymerization of the monomers or oligomers of the thermoplastic, and
an apparatus for assembling the filaments into a filament bundle, thereby forming the multicomponent fiber.

This apparatus is suitable and set up in particular for implementing the likewise proposed method for producing multicomponent/two-component fibers. By means of the proposed apparatus and the proposed method for producing multicomponent/two-component fibers, filaments can be coated as in the case of glass fiber production individually with plastic. As a result, each filament is coated with the amount of plastic needed for further processing. This allows the two-component or bicomponent fibers to be processed further into textiles. This is not possible in the case of the existing use of wires. An advantage of the in situ polymerization is that it can easily be integrated into customary fiber production operations such as glass fiber drawing methods. Accordingly, by providing a suitable applicator and an energy source, more particularly a radiation source, a glass fiber drawing method on a customary glass fiber spinning line can be modified and extended to include in situ coating in accordance with the proposed method.

Glass fibers are produced generally by the drawing of molten glass. In the die drawing process, glass pellets are metered in a die box—the bushing—and melted. The melt emerges through the dies in the form of filaments, and solidifies, allowing the individual filaments to be wound up on a drawing drum. For this purpose the apparatus may comprise a reservoir container, for glass pellets, for example. Located downstream of the dies—for example, glass fiber drawing dies (bushings)—is the applicator for the monomers or oligomers of the thermoplastic. Application by roll or spray is preferred. The applicator in question may be a sizing applicator with sizing roll and sizing trough, or a spray applicator. Installed downstream of the applicator and/or the coating unit is an energy source, more particularly a radiation source. It may be realized, for example, by means of UV radiation. A radiation source which can be used includes UV emitters and also UV LED emitters. In the case of UV LED emitters or UV LED lamps, the wavelength of the radiation is situated in a higher range than in the case of a conventional UV emitter, and they are generally more eco-friendly and efficient. Photoinitiators which, tailored to the wavelength of the UV LED emitters, form radicals and initiate the polymerization are known. The energy source, more particularly radiation source, may serve in particular for radical polymerization. In this range, there is in situ polymerization of the reactive constituents of the precursor composition, comprising monomers, dimers, or oligomers, to form the polymer, hence forming a solid plastic on the surface of the filaments. The material, for a possible second coating, may be passed to a further coating applicator. In this way, a further polymer layer of the same or different kind may be applied. The sheath of thermoplastic polymer may have one or more layers. Prior to assembly, it is also possible to apply a size which facilitates the bundling of the filaments, an example being water or an aqueous solution comprising silanes.

The apparatus further comprises an apparatus for assembling a fiber from a plurality of filaments. After the assembling, the resultant multicomponent, more particularly two-component, fiber may be passed to a winding facility, which generates a reel from the multicomponent fiber, more particularly two-component fiber, obtained, or further processing takes place. The multicomponent, more particularly two-component, fiber produced by the method described and the corresponding apparatus may, correspondingly, be wound up subsequently to form a reel, or processed directly into an organosheet or a shaped article, a component based on an organosheet.

The apparatus may further comprise a shield and/or a suction withdrawal apparatus, with which the ambient air of the monomer application process, and also in the region of the UV lamp, can be drawn off under suction.

By virtue of the method and the corresponding apparatus, a uniform dimensioning of the plastics coating on the fibers is possible. In particular it is possible to provide a reproducible, uniform layer thickness of the thermoplastic around each filament and hence also on each fiber. The uniform and, in particular, complete coating or sheathing is able in turn to ensure the uniform and complete embedding of the fiber cores in the thermoplastic matrix of an organosheet.

In accordance with a further aspect of the invention, a multicomponent fiber, more particularly a two-component fiber, having a fiber core and a thermoplastic sheath, is provided, where the fiber is formed of a plurality of filaments, where the filaments each have a core and a thermoplastic sheath. The multicomponent or two-component fibers may in principle be spun in variable shapes and thicknesses, and varying single-filament diameters are possible. In preferred embodiments, the core of the filaments has a diameter in the range from ≥2 μm to ≤50 μm and/or the thermoplastic sheath has a thickness in the range from ≥0.5 μm to ≤5 μm. It is possible accordingly to provide thin cores in particular having a very thin but advantageously very uniform sheathing. The core of the filaments may preferably have a diameter in the range from ≥3 μm to ≤30 μm, preferably in the range from ≥8 μm to ≤10 μm. The thermoplastic sheath may have a thickness in the range from ≥0.2 μm to ≤3 μm, preferably in the range from ≥0.7 μm to ≤0.9 μm. Fibers with variable diameter may be produced from a plurality of filaments.

In fiber embodiments, the core of the filaments is formed on a material selected from the group encompassing glass, basalt, ceramic, metal, or plastic, preferably of glass. In preferred embodiments the multicomponent fiber is a two-component fiber, more particularly a thermoplastic-glass fiber.

The advantageous properties of the two-component fiber are manifested in particular in the case of further processing to give the fiber composite plastic, more particularly to give organosheets. After production, the two-component fiber can be woven directly, without additional steps of combination of fiber and matrix, and consolidated into organosheets.

Additionally proposed, accordingly, is a method for producing a consolidated, thermoplastic, semifinished, continuous fiber reinforced product or a component comprising it, with the steps of:
producing a multicomponent fiber by the proposed method,
producing a fabric from the multicomponent fiber,
making up the fabric, and
consolidating the made-up fabric into a consolidated, thermoplastic, semifinished, continuous fiber reinforced product or a component comprising it.

The method for producing a consolidated, thermoplastic, semifinished, continuous fiber reinforced product or organosheet or organosheet component has only four steps. Omitted in particular, advantageously, are the otherwise customary steps of the subsequent combining of the components, such as film extrusion, film stacking, and double belt pressing or commingling. Cropping these steps also enables a significant boost to the economics of the production of organosheets and components based thereon. Moreover, the mechanical properties of the organosheets can be significantly improved.

An advantage of the multicomponent or two-component fibers is their very flexible utility. A fabric may be produced by unwinding the fiber from the roll and making a fabric by winding, knitting, weaving, braiding, or laying. After fabric-forming, the fabric is made up. Making up is a term used in production and technology for any kind of division, subdivision into lengths, or imposition of application-specific dimensions. Typically the fabric is cut to size. Lastly, the made-up fabric is consolidated. The purpose of consolidation is to form individual fibers or individual structures into a sheet or a component. Consolidation is preferably accomplished using an established operation with the steps of heating, handling, consolidating, cooling, and demolding.

A great advantage of the multicomponent or two-component fiber is that this fiber can be used directly to produce complex, drapeable geometries. The applications are therefore diverse. Using the method proposed, it is possible in particular to produce a customary, preconsolidated organosheet, or a component directly. Platelike organosheets are customarily produced, with the resultant semifinished products being cut to size and consolidated. This preconsolidated organosheet is then subjected to forming and in-mold coating in subsequent operations, in order to manufacture a component from the organosheet. In this case, in industrial practice, there are also further steps for integrating functionality.

The multicomponent or two-component fiber may be processed directly into complex geometries and components, and so organosheet components can also be formed directly from the two-component fiber by the steps of the method proposed. It is therefore possible to dispense with customary forming and further consolidation. The multicomponent or two-component fiber can be processed advantageously on existing lines.

The organosheets and components obtained from the two-component fibers may have specific properties which are significantly better than those of currently achievable components. As a result, these components can be designed more efficiently in terms of consumption of material. By virtue of the shorter cycle time, the materials are also suitable for mass production, in the automobile sector, for example. Advantageously, good properties can be realized for a number of aspects of organosheets. Hence the incidence of fiber/fiber contact points in the composite can be significantly reduced or even avoided entirely; a much higher uniformity in the distribution of glass fiber and polymer can be achieved; and/or a high fiber volume content can be achieved. The avoidance of contact points and, in particular, the greater uniformity may significantly improve the mechanical properties of the organosheets.

Another subject of the invention concerns a consolidated, thermoplastic, semifinished, continuous fiber reinforced product or organosheet comprising a multicomponent fiber of the invention and/or a multicomponent fiber obtainable by the proposed production method. Advantageously, the organosheet exhibits uniform distribution of fiber and matrix. Additionally, organosheets having defined volume content of the core material can be provided.

The multicomponent fiber, more particularly a two-component fiber, having a fiber core and a thermoplastic sheath, is formed more particularly of a plurality of filaments, where the filaments each have a core and a thermoplastic sheath. The core of the filaments preferably has a diameter in the range from ≥2 μm to ≤50 μm and/or the thermoplastic sheath has a thickness in the range from ≥0.5 μm to ≤5 μm. The core of the filaments may have a diameter in the range from ≥3 μm to ≤30 μm, preferably in the range from ≥8 μm to ≤10 μm. The thermoplastic sheath may have a thickness in the range from ≥0.2 μm to ≤3 μm, preferably in the range from ≥0.7 μm to ≤0.9 μm. Fibers with variable diameter may be produced from a plurality of filaments. In fiber embodiments, the core of the filaments is formed of a material selected from the group encompassing glass, basalt, ceramic, metal, or plastic, preferably of glass. In preferred embodiments the multicomponent fiber is a two-component fiber, more particularly a thermoplastic-glass fiber.

Of particular advantage, furthermore, is the high fiber volume fraction. It has proven possible to realize organosheets having a fiber volume content of more than 75 vol %. Through the proposed production, it is additionally possible to produce organosheets having a fiber volume content of up to the theoretical limit of 91 vol %. In embodiments, the volume fraction of the core material is in the range from ≥75 vol % to ≤91 vol %, based on a total semifinished product volume of 100 vol %. The volume fraction of the core material is customarily referred to as “fiber volume fraction”, based on customary organosheets composed of fiber and matrix. The volume fraction of the core material can be determined thermogravimetrically. A particular result of the high volume fraction of the core material and the consequently low matrix volume fraction is that the weight and the price of organosheets can be reduced significantly. In embodiments, the volume fraction of the core material may be in the range from ≥75 vol % to ≤80 vol %, or in the range from ≥80 vol % to ≤90 vol %, based on a total semifinished product volume of 100 vol %.

The two-component fiber is suitable especially for producing thermoplastic, semifinished, continuous fiber reinforced products. Alternatively, however, the fiber may also be cut and used for producing short fiber reinforced components. “Short fibers” are understood to be fibers having a length in the range from 0.1 mm to 100 mm. A further aspect concerns a method for producing short fiber reinforced components, with the steps of:
producing a multicomponent fiber by the method proposed,
chopping up the multicomponent fiber into short fibers,
producing a fabric from the short fibers, and
making up the fabric into a short fiber reinforced component.

It is possible overall by virtue of the multicomponent or two-component fibers having a glass core and a thermoplastic sheet to reduce the matrix fraction of the finished product and to achieve uniform fiber/matrix distribution. Moreover, various operating steps in the fabrication procedure disappear, since the plastic is introduced during the glass fiber production procedure itself. On the basis of the resultant saving in material, time, and energy, it is possible to improve not only the mechanical properties but also the environmental balance of lightweight construction applications, by virtue of the two-component fibers and methods proposed here.

Examples and figures serving to illustrate the present invention are indicated below.

In the drawings

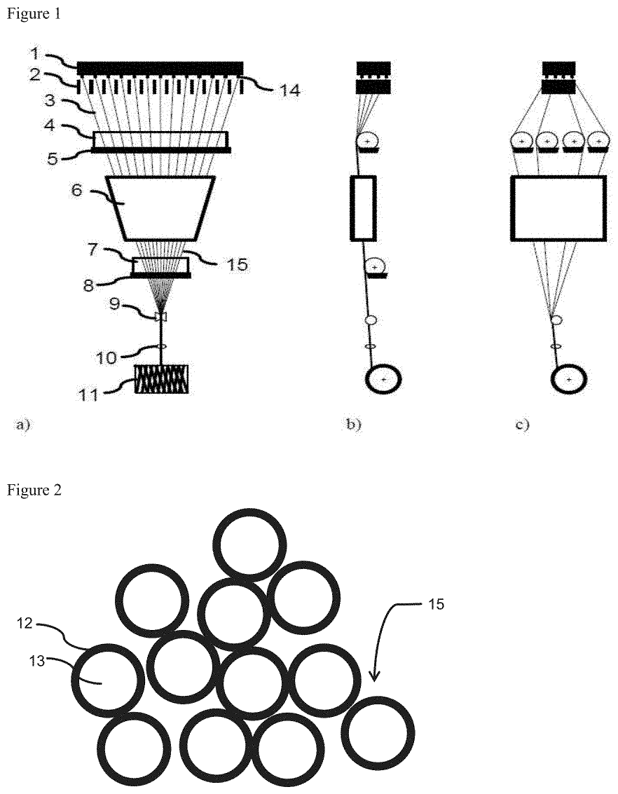

FIG. 1 shows a schematic representation of an apparatus for producing a two-component fiber according to one embodiment of the invention, in a facing view in FIG. 1a) and also a side view in FIG. 1b). FIG. 1c) shows a side view of another embodiment.

FIG. 2 shows a schematic representation of a two-component fiber according to one embodiment.

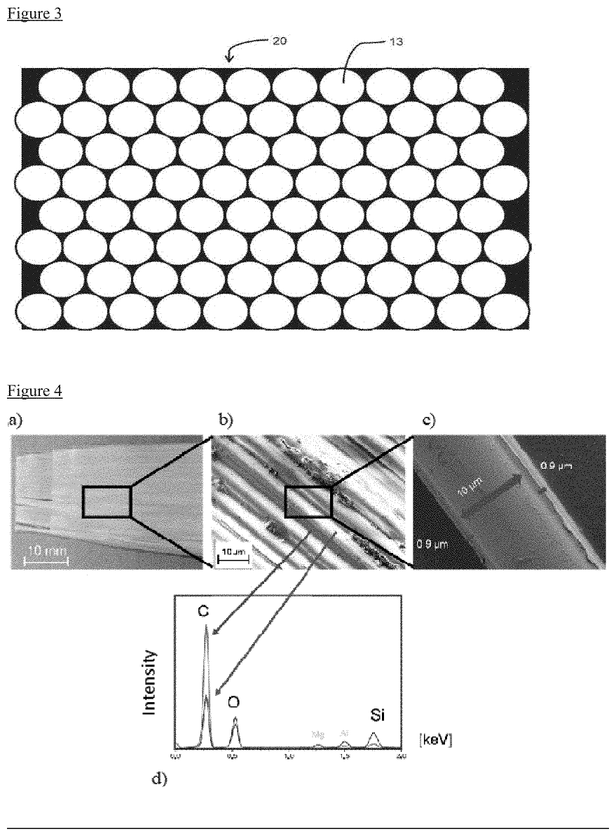

FIG. 3 shows a schematic representation of a cross section through an organosheet according to one embodiment of the invention.

FIG. 4 shows a photograph of an organosheet in FIG. 4a) and also SEM micrographs of an organosheet in FIG. 4b) and of a thermoplastic-glass fiber taken therefrom, in FIG. 4c). FIG. 4d) shows EDX spectra of the areas marked in FIG. 4b).

A spinning line for producing a two-component fiber is shown in a facing view in FIG. 1a) and in a side view in FIG. 1b). It is possible therewith to modify a glass fiber drawing method and extend it to include in situ polymerization. Glass pellets are passed from a reservoir container to furnace 1 (bushing). There the glass is metered and melted. The melt emerges through dies between cooling fins 2 and so solidifies. The glass forms the core of the filaments composed of core and thermoplastic sheath, and is in turn likewise in filament form. The glass cores 3 are subsequently passed through an applicator having a sizing roll 4 and a sizing trough 5 for applying monomers or oligomers of a thermoplastic. Applied there to the glass filaments 3 is a solution comprising monomers and a UV initiator. These filaments are then irradiated with UV light by means of a UV lamp 6 as energy source or radiation source, so generating a thermoplastic sheath on the surface of the glass filaments 3 by in situ polymerization of the monomers. The sheathed filaments then pass through a second sizing apparatus with aftersizing roll 7 and sizing trough 8, for applying an additional aqueous solution, such as a finish or a coating, preferably a solution comprising silanes, after which a two-component fiber is manufactured from the individual filaments in the assembling station 9. This two-component fiber passes through a thread guide 10 to a reel 11, where the fiber is wound and provided for further processing.

FIG. 1c) shows another embodiment of an apparatus in a side view. In this embodiment, monomers of the thermoplastic are applied to the glass filaments 3 by a plurality of separate applicators each with a sizing roll 4 and a sizing trough 5. In this embodiment, the sheathed filaments are assembled to form the two-component fiber after the in situ polymerization initiated by the UV lamp 6, without aftersizing.

FIG. 2 shows a schematic representation of a cross section through two-component fibers 15 produced in this way, with a glass core 13 and a thermoplastic sheath 12, in the form in which the fibers are wound on a reel, for example. FIG. 3 shows a schematic representation of a cross section through a consolidated organosheet 20. In evidence are the uniform distribution and complete sheathing of the glass cores 13 in the thermoplastic matrix of the organosheet.

### EXAMPLE 1

### Radical Polymerization of Various Monomer Compositions

At room temperature (20±2° C.), in preliminary tests, acrylates and other vinyl containing monomers such as styrene, and combinations of these compounds, were admixed with the UV initiator Irgacure® 651 (2,2-dimethoxy-1,2-diphenylethan-1-one, Ciba Specialty Chemicals Inc.). The initiator fraction here was 5 m %, based on the total mass of monomer and photoinitiator. In parallel batches, up to 2.5 m % of triethanolamine (TEA) was added as transfer reagent, and the batches were stirred at 500 rpm in a closed, opaque vessel for 15 minutes at room temperature (RT) or 45° C. The precursor systems were investigated in batches each of 10 mL for their cure times, using the Aktiprint Mini 12 lamp from Eickmeyer GmbH. The power of the emitter was 80 W/cm. The distance between the glass filaments and the center point of the emitter was 4 cm. The cure times were also investigated using the Lighthammer 6 lamp from Heraeus Noblelight Fusion UV Inc. The power of the emitter was 200 W/cm. The distance between the glass filaments and the center point of the emitter was 4 cm.

Tables 1 and 2 below summarize the time taken for at least 99% polymerization (U>99%) under the various conditions tested for each of the monomers and comonomer compositions tested.

TABLE 1
Results of polymerization of monomers

| | Time to U > 99% [s] | | | |
|---|---|---|---|---|
| | 80 W/cm | 200 W/cm | 80 W/cm | 80 W/cm |
| Monomer | RT | RT | 45° C. | RT + TEA |
| Hydroxyethyl acrylate | <1 | <<1 | <<1 | <<1 |
| (HEA) | | | | |
| Ethyl acrylate | 5 | 2 | 2 | — |
| tert-Butyl acrylate | 10 | 4 | 3 | — |
| (t-BuA) | | | | |
| Hydroxyethyl | 28 | 12 | 9 | 12 |
| methacrylate | | | | |
| Methyl methacrylate | 40 | 14 | 10 | 15 |
| Methacrylic acid | 60 | 23 | 18 | — |
| Butyl acrylate | 58 | 22 | 16 | — |
| Isooctyl acrylate | 62 | 20 | 18 | — |
| Styrene | 89 | 34 | 23 | 33 |
| N-Vinylpyrrolidone | 300 | 134 | 104 | — |
| Cyclohexyl acrylate | 300 | 141 | 97 | — |

TABLE 2
Results of polymerization of comonomer compositions

| | Time to U > 99% [s] | | | |
|---|---|---|---|---|
| Comonomer | 80 W/cm | 200 W/cm | 80 W/cm | 80 W/cm |
| compositions | RT | RT | 45° C. | RT + TEA |
| 0% HEA + 100% t-BuA | 10 | 4 | 3 | — |
| 25% HEA + 75% t-BuA | 5 | 2 | 2 | 2 |
| 40% HEA + 60% t-BuA | 1 | <1 | <1 | <1 |
| 50% HEA + 50% t-BuA | 1 | <1 | <1 | <1 |
| 100% HEA + 0% t-BuA | <1 | <<1 | <<1 | <<1 |

As can be seen from tables 1 and 2, not only acrylates and methacrylates but also vinyl-containing compounds and combinations were successfully polymerized. Copolymerizations of these compounds were also successful. The addition of triethanolamine (TEA) increased the reaction rate, but was not essential for the polymerization. Incorporation of nanoscale polymer particles into these systems was also tested, and was possible.

### EXAMPLE 2

### Production of an Organosheet

Glass fibers were spun on a glass fiber spinning line (LIPEX Anlagentechnik und Handel GmbH) The raw glass material took the form of beads having a diameter of 20 mm±0.1 mm. The glass composition of the raw material is summarized in table 3 below:

TABLE 3
Glass composition

| SiO₂ | Al₂O₃ | Fe₂O₃ | CaO | MgO | R₂O | B₂O₃ |
|---|---|---|---|---|---|---|
| 54.1 ± | 14.6 ± | <0.5% | 16.6 ± | 4.6 ± | <0.8% | 6.7 ± |
| 0.5% | 0.4% | | 0.3% | 0.3% | | 0.5% |

R = lithium/sodium/potassium

The molten glass flowed at 1240° C. through 203 die apertures each having a diameter of 1 mm. At takeoff speeds of >1000 m/min, the filaments were first guided via a sizing roll. The speed of the sizing roll in this case was 4 m/min. The size used was a monomer system containing 10 mL of hydroxyethyl acrylate, 0.505 g of Irgacure® 651, and 0.253 g of TEA (triethanolamine). The in situ polymerization was initiated by means of the Aktiprint Mini 12 UV lamp (Eickmeyer GmbH) at an emitter power of 80 W/cm. The filaments were subsequently assembled into the fiber and wound by means of a reel. The spinning operation was conducted over 8 hours without spin break. The cross section of the overall fiber bundle here was 1.5 mm×2 mm. The linear density of the yarn was 50 tex.

The two-component fiber was subsequently wound from the reel and placed by hand into a pneumatic press comprising a pressing tool, a thermal conditioning device, and a suction apparatus, and was cut to dimensions of 5 cm×1.5 cm.

The temperature in the cavity was adjusted using the TT-390 thermal conditioning device (TOOL-TEMP AG, Sulgen, Switzerland). Heat transfer into the press cavity took place using the TOOL-THERM SH-3 heat transfer oil (TOOL-TEMP AG, Sulgen, Switzerland). This oil is heated or cooled in the thermal conditioning device and passed via hoses through the holes in the tool. The indirect thermal conditioning system possessed a heating power of 24 kW and a cooling power of 90 kW at 360° C. The temperature was measured and controlled by way of the thermal conditioning device. The housing containing the suction apparatus completely surrounded the press and thermal conditioning device. This allowed the press to be employed at high temperatures, since the gases given off from the thermal conditioning device were drawn off directly under suction. The heating and cooling system represents the connection between the thermal conditioning device and the tool.

The tool stroke h_{W} describes the maximum opening of the tool. The thickness of the material inserted into the cavity is therefore limited to this stroke. The cavity describes the region which is filled with the material for consolidation. The press cavity used was 260 mm long, 60 mm wide, and 10 mm deep. During pressing, the pressing ram was pressed into the cavity under pneumatic pressure.

The laid and cut fabric of 5 cm×1.5 cm was inserted after a 10-minute warming phase at a tool temperature of 250° C. and hence above the melting temperature of the thermoplastic. The workpiece was pressed in the cavity for 6 minutes at a pressure of 100 bar. During this time, after a solidification phase of 2 minutes, the tool temperature was lowered and the pressed organosheet was removed.

FIG. 4 shows a photograph in FIG. 4a) and SEM micrographs of the organosheet at different magnifications in FIGS. 4b) and c). The organosheet obtained was investigated by electron microscopy, using a Zeiss Neon 40 scanning electron microscope equipped with EDX detector. SEM micrographs of the sample were obtained by using the InLens detector (secondary electrons) and the SE detector (secondary and backscattered electrons) at an acceleration voltage of 2 kV. The diameter of the glass fiber core was found to be 10 μm, the layer thickness of the thermoplastic sheath 0.9 μm.

FIG. 4d) shows the EDX spectra of the area denoted in FIG. 4b). The spectrum of the measurement point showed a ratio of the elements carbon, oxygen, and silicon and also fractions of magnesium and aluminum, which agreed with an assumption of 70 to 80 vol % of glass fibers in the organosheet.

### EXAMPLE 3

### Characterization of the Fiber Volume Contents

The fiber volume contents of the organosheet were characterized through measurement by thermogravimetric analysis, using a TGA/DSC 1 instrument from Mettler-Toledo AG. Ten samples of the organosheet produced according to example 2, with a weight of 8 mg to 10 mg, were treated thermally at a temperature of up to 700° C. with a heating rate of 7 K/min. At 700° C. the temperature was held for 30 minutes. The weight loss resulting from the carbonization of the matrix was determined at this point. Nine samples out of the ten measured show volume fractions of the glass core of 83 to 86 vol %, based on the total volume.

The fiber volume content was likewise determined by carbonization of the matrix in a muffle furnace. This was done utilizing samples of 20 g of the organosheets under the same thermal settings (7 K/min heating rate up to a temperature of 700° C. for 30 minutes) as for the TGA. Here as well, the volume fractions of the glass were confirmed at more than 80 vol %.

All in all, the examples show that organosheets having a high volume fraction of the glass core could be successfully produced.

### EXAMPLE 4

### Investigation of the Initiator Fraction

Also investigated was the effect of the photoinitiator on the operating regime. For this purpose, glass fibers were spun on a glass fiber spinning line (LIPEX Anlagentechnik und Handel GmbH) as described in example 2, but with the use as size of monomer systems containing hydroxyethyl acrylate, TEA (triethanolamine) and 1 or 5 mass %, based on the acrylate, of Irgacure® 651. The spun filaments were assembled into fiber and wound using a reel.

In this case it was found that the drawing speed of the glass fibers in the spinning operation using 5 mass % of initiator was four times higher as compared with the use of 1 mass % of photoinitiator. This shows that the fraction of the photoinitiator had a significant effect on the operating regime.

The spinning operation was repeated for sizes comprising monomer systems containing hydroxyethyl acrylate, TEA (triethanolamine), and 1 and 5 mass %, based on the acrylate, of Irgacure® 651, in each case at constant spinning speeds of 60 and 120/min. The two-component fiber obtained was subsequently unwound from the reel and pressed to organosheets by hand in a pneumatic press, as described in example 2. The fiber volume contents of the organosheet were characterized by thermogravimetric analysis as described in example 3.

In this case it emerged that the fraction of plastic in the glass fibers when using 5 mass % of initiator was significantly lower than when using 1 mass % of photoinitiator. The assumption is that there is a relationship between the amount of photoinitiator used and the fraction of plastic which is formed on the glass fiber surface. Without being tied to a theory, it is assumed that the reason for this lies in the exothermic reaction of the polymerization, causing the evaporation temperature of the monomer system to be exceeded. At 5 mass % of photoinitiator, a more exothermic reaction is assumed, resulting in more monomer—which is actually present for forming polymer—being evaporated.

### LIST OF REFERENCE NUMERALS

1 Bushing (furnace)
2 Cooling fins
3 Glass core
4 Sizing roll
5 Sizing trough
6 UV lamp
7 Aftersizing roll
8 Sizing trough
9 Assembling
10 Thread guide
11 Reel
12 Thermoplastic sheath
13 Glass core
14 Die
15 Two-component fiber
20 Organosheet

1. A method for producing a multicomponent fiber, wherein the fiber is formed from a plurality of filaments, where the filaments each have a core and a thermoplastic sheath, and where the sheath is generated during the production of the filaments by in situ polymerization of monomers or oligomers of the thermoplastic on the surface of the core.

2. The method as claimed in claim 1, wherein the core of the filaments is produced by die drawing methods or spinning methods.

3. The method as claimed in claim 1, wherein the core of the filaments is formed of glass, basalt, ceramic, metal, or plastic.

4. An apparatus for producing a multicomponent fiber, comprising the following components:
a plurality of dies for forming the cores of a plurality of filaments,
at least one applicator for applying monomers or oligomers of a thermoplastic to the cores of the filaments,
at least one source of energy or radiation for in situ polymerization of the monomers or oligomers of the thermoplastic, and
an apparatus for assembling the filaments into a filament bundle, thereby forming the multicomponent fiber.

5. A multicomponent fiber wherein the multicomponent fiber is formed of a plurality of filaments, where the plurality of filaments each have a core and a thermoplastic sheath.

6. The multicomponent fiber as claimed in claim 5, where the core of the filaments has a diameter in the range from ≥2 μm to ≤50 μm and/or the thermoplastic sheath has a thickness in the range from ≥0.1 μm to ≤5 μm.

7. The multicomponent fiber as claimed in claim 5, wherein the fiber is a two-component fiber.

8. A method for producing a consolidated, thermoplastic, semifinished, continuous fiber reinforced product or a component comprising it, the method comprising the steps of:
producing a multicomponent fiber by the method as claimed in claim 1,
producing a fabric from the multicomponent fiber,
making up the fabric, and
consolidating the made-up fabric into a consolidated, thermoplastic, semifinished, continuous fiber reinforced product or a component comprising it.

9. A consolidated, thermoplastic, semifinished, continuous fiber reinforced product comprising a multicomponent fiber as claimed in claim 5.

10. The semifinished product as claimed in claim 9, wherein the volume fraction of the cores of the multicomponent fiber is in the range from ≥75 vol % to ≤91 vol %, based on a total semifinished product volume of 100 vol %.

11. A method for producing short fiber reinforced components, the method comprising the steps of:
producing a multicomponent fiber by the method as claimed in claim 1,
chopping up the multicomponent fiber into short fibers,
producing a fabric from the short fibers, and
making up the fabric into a short fiber reinforced component.

12. The method as claimed in claim 1, wherein the core of the filaments is formed of glass.

13. The multicomponent fiber as claimed in claim 7, wherein the fiber is a thermoplastic-glass fiber.

14. A consolidated, thermoplastic, semifinished, continuous fiber reinforced product comprising a multicomponent fiber obtainable by the method of claim 1.

15. The semifinished product as claimed in claim 10, wherein the volume fraction of the cores of the multicomponent fiber is in the range from ≥75 vol % to ≤80 vol %.

16. The semifinished product as claimed in claim 10, wherein the volume fraction of the cores of the multicomponent fiber is in the range from ≥80 vol % to ≤90 vol %.
